(19) United States
(12) Patent Application Publication
(10) Pub. No.: US 2005/0069244 A1
(43) Pub. Date: Mar. 31, 2005

(54) Flexible distributed wireless signal system and method

(76) Inventors: Miguel Dajer, Succasunna, NJ (US); Michael F. Garyantes, Warren, NJ (US); Peter Giannoglou, Towaco, NJ (US); Peter K. LaConte, West Paterson, NJ (US)

Correspondence Address: CARLSON, GASKEY & OLDS, P.C., 400 WEST MAPLE ROAD, SUITE 350, BIRMINGHAM, MI, 48009, US

(21) Appl. No.: 10/670,751

(22) Filed: Sep. 25, 2003

(51) Int. Cl. G02B 6/12

(52) U.S. Cl. 385/14; 385/31

(57) ABSTRACT

A system and method distributes wireless signals to areas remote from a base station by incorporating a backplane fiber card connected to a backplane in a base station and a radio fiber card connected to a radio. The backplane fiber card and the radio fiber card are connected together by one or more fiber links, which carry signals between the two fiber cards. The radio can therefore be placed at any location within the length of the fiber link, remote from the backplane. The backplane fiber card can be plugged into a radio card slot in the backplane. In one embodiment, the fiber cards have connectors that connect to standard backplane and radio structures, allowing the invention to be incorporated in existing systems without any modifications to the radio or the backplane itself.

### BACKGROUND OF THE INVENTION

1. Field of the Invention

The present invention relates to wireless communication systems.

2. Description of the Related Art

Traditional wireless systems often use base stations to distribute wireless signals, such as RF signals, over a selected area. Base stations usually include one or more radio cards physically plugged into corresponding radio slots in a backplane or equivalent interconnection method, such as a cable harness. The base station acts a hybrid structure having a digital portion and a radio portion, where digital signals are received through a digital network connection (i.e., the backplane), processed, and then converted to RF signals by a radio before interfacing with an RF structure (e.g., RF amplifiers, RF filters, RF antennas, etc.). Because of the many functions that the radio card should execute, the technology in both the backplane and the radio require sophisticated design and implementation as well as a great deal of development effort, making them relatively expensive.

Wireless service providers can increase or change coverage area by increasing the number of base stations in a given area. However, increasing the number of base stations also increases the cost of covering the area due to the additional base stations.

Consequently, there is a desire for a signal distribution system that improves wireless coverage while minimizing the amount of hardware needed to provide the improved coverage.

### SUMMARY OF THE INVENTION

The present invention may be directed to a system and method for distributing wireless signals to areas remote from a base station. More particularly, the present invention provides a method allowing at least one radio to be located remotely from a backplane instead of requiring the radio to be physically connected to the backplane. In one embodiment, the invention incorporates a backplane fiber card connected to a backplane in a base station and a radio fiber card connected to a radio. In one embodiment, the backplane fiber card and the radio fiber card are connected together by one or more fiber links, which carry signals between the two fiber cards. The fiber link provides a communication link between the radio fiber card and the backplane while allowing the radio fiber card to be physically located away from the backplane rather than connected to the backplane. The backplane fiber card provides a communication link between the radio fiber card and the backplane without requiring the radio fiber card itself to be connected to the backplane. The radio can therefore be placed at any location within the length of the fiber link, remote from the backplane.

In one embodiment, the backplane fiber card can be plugged into a radio card slot in the backplane. During use, the backplane fiber card may intercept signals for the radio and may pass them through the fiber link along to the radio fiber card, which in turn may send them to the remote radio. Similarly, the radio fiber card may intercept signals for the backplane and may send the signals to the backplane fiber card, which in turn may send them to the backplane. The fiber cards may be transparent to the backplane and the radio. By physically separating the signal processing functions of the backplane with the signal transmission and receiving functions of the radio, the invention allows the base station and the radio to be placed at separate locations.

In another embodiment, the fiber cards may have connectors that connect to standard backplane and radio structures. This allows the invention to be incorporated in existing systems without any modifications to the radio or the backplane itself, thereby allowing the inventive system to take advantage of any improvements to the radio and backplane as well as simplify system management. Further, using standard connectors allows a single backplane to support both remote and non-remote radios, further increasing system flexibility.

### BRIEF DESCRIPTION OF THE DRAWINGS

FIG. 1 is a representative diagram of a wireless system according to one embodiment of the invention;

FIG. 2 is a representative diagram of a wireless system according to another embodiment of the invention;

FIG. 3 is a representative diagram of a wireless system according to yet another embodiment of the invention; and

FIG. 4 is a representative diagram of a backplane fiber card according to one embodiment of the invention; and

FIG. 5 is a representative diagram of radio fiber card according to one embodiment of the invention.

### DETAILED DESCRIPTION

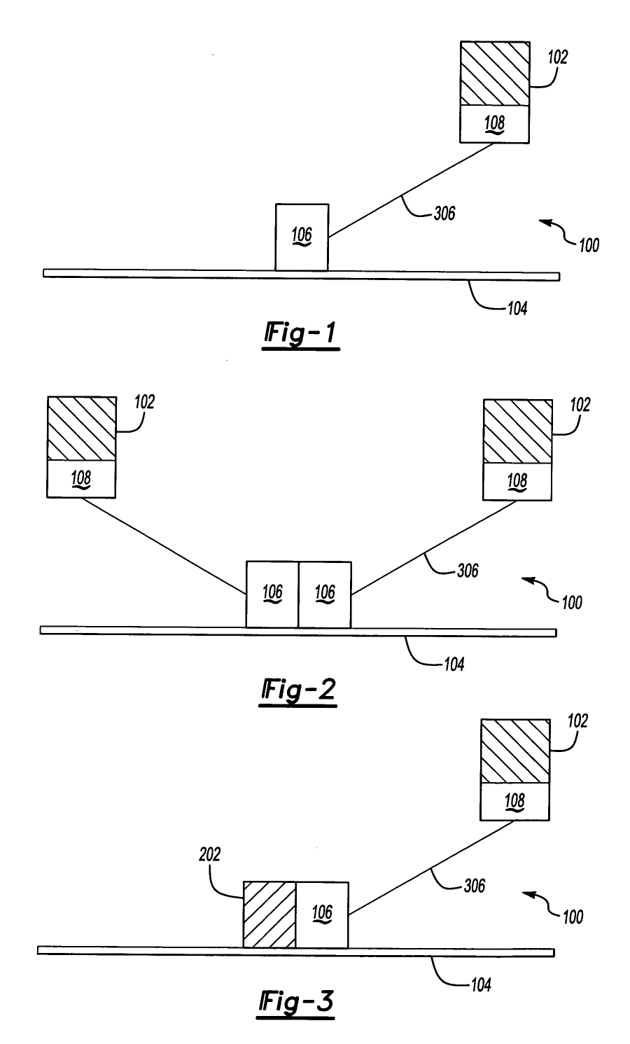

FIG. 1 illustrates one possible approach for a distributed wireless system 100 according to one embodiment of the invention. In the invention, one or more remote radios 102 are connected to a backplane 104 via fiber cards 106, 108. In this description, the term “backplane” generically encompasses any interconnection structure known in the art. Note that the connection between the backplane 104 and the radio card is not a direct, physical connection. Instead, a backplane fiber card 106 is plugged into a radio slot, which would normally accommodate the radio 102, in the backplane 104. A radio fiber card 108 is attached to the remote radio 102, allowing the remote radio 102 to transmit and receive signals to and from the backplane 104 via the backplane fiber card 106. For clarity, the word “transmission” will cover both uplink and downlink communication between the radio 102 and the base station.

The fiber cards 106, 108 form a link between the digital portion of the system (i.e., the backplane) and the radio 102. The base station, which incorporates the backplane 104, is therefore not limited by the desired transmission location. Instead, the backplane 104 can be placed at any desired central, safe location while only the remote radio 102 is placed at the desired transmission location. For example, if signal transmission is desired at a top of a building, the backplane 104 can be placed in, for example, a basement or other accessible secure area while the remote radio 102 is placed at the top of the building for increased signal coverage. The backplane 104 can therefore send its digital signals through the fiber cards 106, 108 to be transmitted through the remote radio 102, covering locations that are remote from the backplane 104 location.

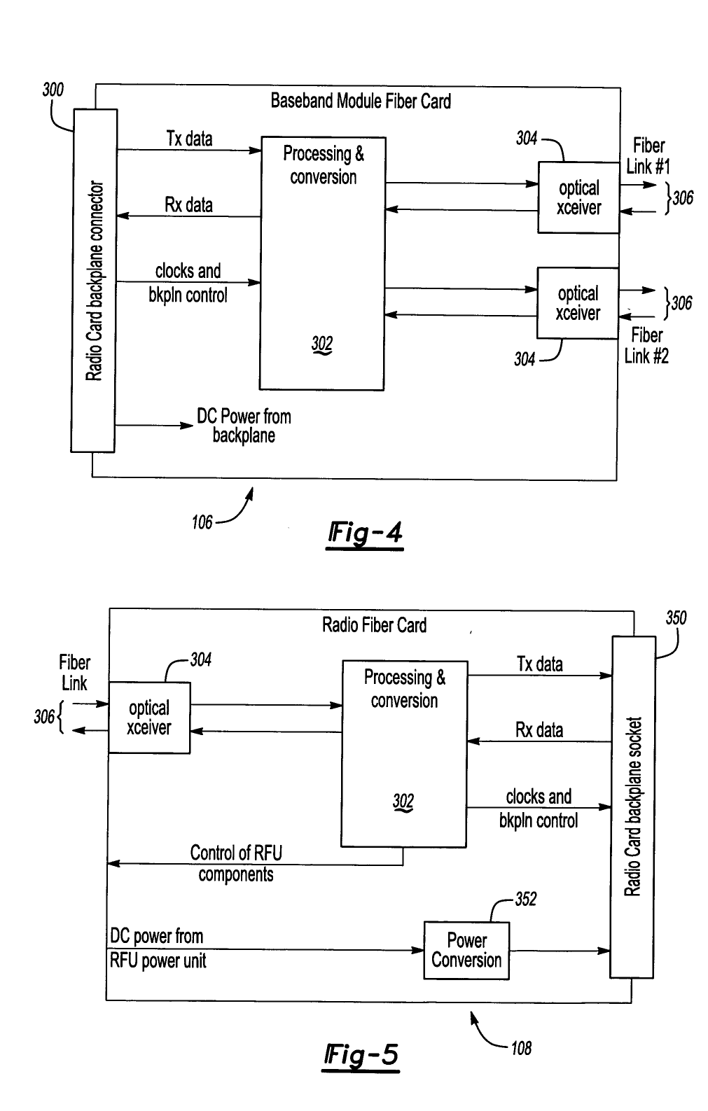

The backplane fiber card 106 may have a structure that can fit in a conventional radio card slot in the backplane 104. Similarly, the radio fiber card 108 may have a structure that can couple with a conventional, standard radio 102. Details of a fiber card structure according to one embodiment will be explained in greater detail below with respect to FIGS. 4 and 5. Generally, the fiber cards 106, 108 allow standard radios to serve as remote radios 102 without any modifications to the radio 102 itself. In one embodiment, the backplane 104 need not distinguish between the backplane fiber card 106 and the radio 102, thereby delivering signals to the backplane fiber card 106 as if it were a radio 102. The backplane fiber card 106 then intercepts the signals, sends them to the radio fiber card 108, which in turn sends them to the radio 102 for use. In other words, the fiber cards 106, 108 give the system 100 the illusion that the radio 102 itself is plugged into the backplane 104 in the base station when it is in fact at a location remote from the base station. By ensuring that the backplane 104 in the distributed system 100 behaves like a traditional, non-distributed system, software and features designed for traditional systems can be carried over and reused in the inventive distributed system 100 without any modifications.

The fiber cards 106, 108 therefore can distribute signals from the backplane 104 to the radio 102 by intercepting the signals intended for a radio connected to the backplane 104 and then reproducing those signals to a remotely located radio 102 (i.e., a radio that is not connected to the backplane 104). In essence, the invention divides the digital processing conducted by the backplane from the signal transmission conducted by the radio into two geographically separate areas.

Incorporating the fiber cards 106, 108 not only allows radios 102 to be located remotely, but also allows a single base station to service multiple remote radios 102 in different locations. FIG. 2 illustrates an embodiment where a single backplane 104 links to multiple remote radios 102. This allows multiple radios 102 to pool their digital resources into one base station. Generally, this embodiment distributes radio energy without having to correspondingly distribute digital access to the system via additional base stations. In other words, multiple radios 102 can be supported by a single piece of digital equipment; if radio energy is required in ten areas, for example, the invention allows a single base station having the backplane 104 to support ten remote radios 102 in the desired areas rather than requiring ten separate base stations, one in each desired area. This reduces the costs of providing radio energy to multiple areas, even if those areas are far apart from each other.

FIG. 3 shows another embodiment of the invention where remote radios 102 and non-remote radios 202 are connected to the same backplane 104. Because the invention does not require any changes in the backplane 104 or radio 102 to take advantage of distributed wireless signals, a single backplane 104 can support both remote radios 102 and non-remote radios 202 without any modifications to either the backplane 104 or the radios 102, 202. Instead, the non-remote radio 202 can simply be plugged into one radio slot in the backplane 104 while the backplane fiber card 106 is plugged into another radio slot in the same backplane 104. Thus, a base station incorporating the system shown in FIG. 2 combines both the traditional (non-distributed) and the inventive distributed approaches in the same base station.

Regardless of the specific configuration of the system 100, the backplane fiber card 106 and the radio fiber card 108 should be compatible with the backplane 104 and radio 102, respectively, so that signals can travel transparently between the backplane 104 and the radio 102. FIG. 4 is a representative diagram of the backplane radio card 106 according to one embodiment of the invention. The backplane radio card 106 has a backplane connecter 300 that is compatible with the connection structure of a radio slot in the backplane 104 so that the backplane radio card 106 can plug into the radio card slot.

The backplane fiber card 106 can contain any appropriate signal processing and conversion circuitry 302 that can relay the downlink and uplink signals between the backplane 104 through the connector 300 and one or more optical transceivers 304, which are connected to fiber links 306 that link the backplane fiber card 106 to the radio fiber card 108. In one embodiment, the circuitry 302 can be any circuitry that is programmed to transmit and receive data and to respond to clocks and backplane control signals from the backplane via any known manner. In the illustrated embodiment, the backplane fiber card 106 receives DC power from the backplane as well.

FIG. 5 shows the radio fiber card 108, which communicates with the backplane fiber card 106 through the fiber links 306. The components in the radio fiber card 108 are comparable to the components in the backplane fiber card 106, such as the signal processing and conversion circuitry 302. The radio fiber card 108 includes a radio connector 350 that can be plugged into the radio 102. Note that the radio fiber card 108 is connected to one fiber link 306, while the backplane fiber card 106 may be connected to two or more fiber links 306 (FIG. 4 shows two). Thus, a single backplane fiber card 106 can be configured to support more than one radio fiber card 108 (two in this example). Further, in this embodiment, the radio fiber card 108 receives DC power from the power unit in the radio it is connected to and converts it in a power converter 352.

In use, the remote radios can be placed in any desired location where signal transmission is needed, limited only by the length of the fiber links 306 and not by the location of the backplane. The base station can therefore be placed at a location that is convenient to the wireless service provider, while the remote radios can be transferred to where the wireless signals are actually needed. The number of cell sites, which each require a base station, can therefore be minimized, reducing system cost. Further, using common parts between the inventive distributed wireless system 100 and conventional, non-distributed wireless system minimizes part and development costs, streamlines network management, and provides more efficient inventory management and evolution of new system features.

Also, by using fiber cards to distribute signals to remote locations, the invention centralizes digital signal processing while allowing one base station to transmit signals over multiple radio locations, reducing the cost of the wireless system. The fiber cards in the invention also eliminates the need for specialized radios to distribute the signals. Instead, the invention incorporates the fiber cards into an existing system having traditional radio cards, allowing the inventive distributed system to take advantage of any improvements in the traditional radio cards.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, this method, system and portions thereof and of the described method and system may be implemented in different locations, such as network elements, the wireless unit, the base station, a base station controller, a mobile switching center and/or radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

1. A wireless communication system, comprising:
at least one radio at a location remote from a backplane; and
at least one communication link coupling said at least one radio to the backplane, wherein the communication link carries signals between the backplane and said at least one radio at the location remote from the backplane.

2. The system of claim 1, wherein said at least one communication link is a fiber link connecting said at least one radio to the backplane.

3. The system of claim 1, comprising at least one backplane card attached to the backplane, wherein the communication link is connected to the backplane card.

4. The system of claim 3, wherein the backplane card is coupled with a radio card slot in the backplane.

5. The system of claim 1, comprising at least one radio card connected to said at least one radio, wherein the communication link is connected to the radio card.

6. The system of claim 5, comprising at least one backplane card attached to the backplane, wherein the communication link is connected to the backplane card and the radio card.

7. The system of claim 6, wherein said at least one radio card comprises a plurality of radio cards, and wherein the backplane card is connected to said plurality of radio cards.

8. The system of claim 6, wherein said at least one card comprises a plurality of radio cards and wherein said at least one backplane card comprises a plurality of backplane cards attached to the backplane, wherein each backplane card is connected to at least one of said plurality of radio cards via said at least one communication link.

9. The system of claim 6, comprising at least one non-remote radio, wherein said at least one non-remote radio is plugged into a first radio card slot in the backplane and said at least one backplane fiber card plugged into a second radio card slot in the backplane and connected to said at least one radio card via said at least one communication link.

10. A connection apparatus for a wireless communication system, comprising:
a backplane fiber card having a backplane connector;
a radio fiber card having a radio connector; and
at least one fiber link connecting the backplane fiber card and the radio fiber card.

11. The connection apparatus of claim 10, wherein the backplane connector and the radio connector each have a standard configuration for connection to a backplane and a radio, respectively.

12. The connection apparatus of claim 10, wherein the backplane fiber card and the radio fiber card each comprise at least one optical transceiver connected to said at least one fiber link.

13. The connection apparatus of claim 10, wherein the backplane fiber card comprises a plurality of fiber links, each fiber link connected to one radio fiber card.

14. A method of transmitting a signal between a backplane and a remote radio, comprising:
intercepting the signal in a backplane card connected to the backplane; and
transmitting the signal through a communication link connected to the backplane card to the remote radio.

15. The method of claim 14, comprising intercepting the signal from the backplane card in a radio card attached to the remote radio.

16. The method of claim 14, comprising:
transmitting a second signal from the backplane to a non-remote radio connected to the backplane, wherein the remote radio and the non-remote radio are in communication with the backplane.

17. The method of claim 14, comprising:
intercepting a second signal in the backplane card;
transmitting a second signal from the backplane to a second remote radio through a second communication link connected to the backplane card.

18. The method of claim 14, wherein the intercepting and transmitting steps are conducted to a plurality of remote radios.
